(19) United States
(12) Patent Application Publication
(10) Pub. No.: US 2025/0378180 A1
(43) Pub. Date: Dec. 11, 2025

(54) Secure and Efficient Method to Prevent Leakage in Personalized AI Models via Weight Decomposition

(71) Applicant: QUALCOMM Incorporated, San Diego, CA (US)

(72) Inventors: Simyung CHANG, Suwon (KR); Hyoungwoo PARK, Seoul (KR); Eungyo SUH, Seoul (KR); Eunji KIM, Seoul-si (KR)

(21) Appl. No.: 18/736,902

(22) Filed: Jun. 7, 2024

(51) Int. Cl. G06F 21/60; G06F 21/55

(52) U.S. Cl. CPC G06F 21/602; G06F 21/556

(57) ABSTRACT

Various embodiments include systems and methods for securing artificial intelligence models in a computing device. Embodiment methods may include decomposing original model weights into lower-rank matrices including a first matrix, a second matrix, and a third matrix. The first matrix and the second matrix may be designated for processing within an unsecured execution environment (UEE). The third matrix (Σ) may be designated for processing within a secure execution environment (SEE). The third matrix (Σ) may be encrypted in the UEE and transferred to the SEE where it may be encrypted. Secure computations to generate inference results may be performed in the SEE, and the inference results or third matrix (Σ) stored in encrypted form in a secure memory within the SEE.

### BACKGROUND

The proliferation of artificial intelligence (AI) technology has introduced significant privacy and data security concerns, notably with the emergence of personalized AI models. These models, which are designed to incorporate and use extensive personal data, may significantly increase the risks associated with privacy breaches that could cause far more damage than those associated with traditional data breaches.

### SUMMARY

Various aspects include methods and computing systems implementing such methods for preventing leakage of personal information in personalized AI models. Various aspects may include a processor-implemented method of securing AI models in a computing device including retrieving, by a first processor of the computing device, an AI model that includes original model weights (W), decomposing the original model weights (W) by the first processor into lower-rank matrices including a first matrix (U), a second matrix (V), and a third matrix (Σ), designating, by the first processor, the first matrix (U) and the second matrix (V) for processing within an unsecured execution environment (UEE), designating, by the first processor, the third matrix (Σ) for processing within a secure execution environment (SEE), encrypting, by the first processor, the third matrix (Σ) in the UEE, transferring the encrypted third matrix (Σ) to the SEE, decrypting the encrypted third matrix (Σ) by a second processor within the SEE, applying the third matrix (Σ) to an adapter component by the second processor in the SEE to perform secure computations and generate inference results, and storing the inference results or third matrix (Σ) in encrypted form in a secure memory within the SEE.

In some aspects, the third matrix (Σ) may be a diagonal matrix that includes singular values of the original model weights (W) derived from the decomposition operations that include sensitive, private, or personal data characteristics or features. In some aspects, designating the third matrix (Σ) as the secure component for processing within the SEE further may include the first processor encrypting and storing the third matrix (Σ) in encrypted form in the secure memory within the SEE.

Some aspects may further include performing non-sensitive computations involving the first matrix (U) and the second matrix (V) by the first processor in the UEE, performing the sensitive computations involving the third matrix (Σ) by the second processor within the SEE, and synchronizing computational results between the SEE and UEE by one of the first or second processors.

Some aspects may further include training the AI model using the first matrix (U) and the second matrix (V) by the first processor in the UEE for non-sensitive training data, and using the third matrix (Σ) by the second processor in the SEE for sensitive training data. Some aspects may further include monitoring data flows between the SEE and the UEE to detect updates or potential security breaches.

In some aspects, decomposing the original model weights (W) into the lower-rank matrices including the first matrix (U), the second matrix (V), and the third matrix (Σ) may include the first processor using a matrix decomposition algorithm to decompose the original model weights (W) into the first matrix (U), the second matrix (V), and the third matrix (Σ).

Further aspects include a computing system or computing device having a processor configured with processor-executable instructions to perform various operations corresponding to the methods summarized above. Further aspects may include a non-transitory processor-readable storage medium having stored thereon processor-executable instructions configured to cause a processor to perform various operations corresponding to the method operations summarized above. Further aspects may include a computing system or computing device having means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components in a system-in-package (SIP) that may be included in a computing device and configured to implement some embodiments.

FIGS. 2A and 2B are component block diagrams illustrating an example of secure computing system architecture that may be used to implement some embodiments.

FIGS. 3A-3D are component block diagrams that illustrate more detailed secure computing architectures that are suitable for implementing the various embodiments.

FIGS. 4-6 illustrate components and operations in a computing system in which the operations of the AI models are separated between a secure and non-secured execution or processing environments in accordance with various embodiments.

FIGS. 7-9 are process flow diagrams illustrating methods of performing weight decomposition and securing artificial intelligence (AI) models in accordance with some embodiments.

FIG. 10 is a component block diagram illustrating an example computing device in the form of a laptop that is suitable for implementing some embodiments.

FIG. 11 is a component block diagram illustrating an example wireless communication device suitable for use with various embodiments.

FIG. 12 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, various embodiments include methods, and computing devices and processing systems configured to implement the methods, of securing artificial intelligence (AI) models. In some embodiments, the methods may include retrieving an AI model that includes original model weights (W) and decomposing the original model weights (W) into lower-rank matrices, which may include a first matrix (U), a second matrix (V), and a third matrix (Σ). The methods may further include designating the first matrix (U) and the second matrix (V) for processing within an unsecured execution environment (UEE), designating the third matrix (Σ) for processing within an adapter component in a secure execution environment (SEE) (e.g., a Trusted Execution Environment (TEE), etc.), encrypting the third matrix (Σ) before sending to the SEE and decrypting the third matrix (Σ) within the SEE to perform secure computations, and encrypting and storing the designated secure component in encrypted form in secure flash memory within the SEE.

Thus, some embodiments may include retrieving and decomposing weights of AI models into three lower-rank matrices (U, V, and Σ) such that matrices U and V process less sensitive data and matrix Σ processes more sensitive data.

Some embodiments may further include performing non-sensitive computations involving the first matrix (U) and the second matrix (V) in the UEE, performing the sensitive computations involving the third matrix (Σ) within the SEE, and synchronizing computational results between the SEE and UEE. In some embodiments, training the AI model may include using the first matrix (U) and the second matrix (V) in the UEE for non-sensitive training data, and using the third matrix (Σ) in the SEE for sensitive training data. In some embodiments, designating the third matrix (Σ) as the secure component for processing within the SEE may include encrypting and storing the third matrix (Σ) in encrypted form in secure flash memory within the SEE. In some embodiments, decomposing the original model weights (W) into the lower-rank matrices, which may include the first matrix (U), the second matrix (V), and the third matrix (Σ), may include using a matrix decomposition algorithm to decompose the original model weights (W) into the lower-rank matrices which may include the first matrix (U), the second matrix (V), and the third matrix (Σ).

In some embodiments, the methods may include decomposing AI model weights into (simpler) lower-rank matrices to create a secure adapter that may be integrated into the AI models and used to secure the AI models. In some embodiments, the methods may include controlling and orchestrating sensitive and non-sensitive components across secure and normal operational environments to reduce risks (e.g., privacy risks, security risks, etc.) associated with using personalized AI models. Some embodiments may allow for performing “dual-world” operations in which important data components are processed and stored within a SEE to improve data security. Some embodiments may use weight decomposition and secure fragment management techniques to provide robust frameworks for integrating secure, private, or personalized information into AI models.

Some embodiments may allow for integrating new adapters without extensive modifications or pre-training. For these and other reasons, the embodiments provide a scalable and secure solution for advanced AI applications that improve the performance and functioning of the computing devices and software applications operating thereon.

The term “computing device” is used herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo switch™), media players (e.g., digital versatile disc (DVD) players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IOT) devices, other similar devices that include a programmable processing system that may be configured to provide the functionality of various embodiments.

The term “processing system” is used herein to refer to one or more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled via high-speed communication circuitry and packaged in proximity, such as on a single motherboard, in a single UE, or in a single CPU device. The proximity of the SoCs facilitates high-speed communications and the sharing of memory and resources.

The term “secure execution environment” (SEE) is used herein to refer to a dedicated processing area within a computing device that is designed to handle sensitive operations. An SEE may include a “Trusted Execution Environment” (TEE). These environments may be isolated from the main operating system to prevent unauthorized access and manipulation. SEEs may be used to provide robust security features for cryptographic operations, secure boot, and secure storage. SEEs are often used for privacy-preserving computations in devices handling sensitive personal data for these and other reasons.

The term “unsecured execution environment” (UEE) is used herein to refer to the standard computing environment or “normal world” within a computing device in which routine processing tasks are performed. Unlike the SEE, the UEE does not include specialized security measures for handling sensitive operations and data. The UEE is typically where most user-facing applications and non-critical system processes are executed. UEEs are designed for general computing, offering a more flexible and less restrictive operating space than SEEs. However, due to their open nature, UEEs are less protected against potential security threats and are thus often inadequate for processing confidential or sensitive information.

The term “secure monitor call” (SMC) is used herein to refer to a mechanism for changing the processor execution mode from secure to non-secure and vice-versa. When a processor executes the SMC, the processor or core enters a Secure Monitor mode to execute the Secure Monitor code. This call (SMC) may be routed via a Hosted Hypervisor for mode switch in virtualization systems. SMCs may be used for tasks such as requesting access to hardware resources, obtaining information about the entire system, or triggering the host to perform certain actions on behalf of the guest. To prevent unauthorized or malicious access, SMCs are typically implemented with strict security measures, such as authentication and access controls.

The term “AI model” is used herein to refer to computational frameworks and/or information structures (e.g., decision nodes, etc.) that are used to perform tasks that typically require human-like intelligence. In some embodiments, an AI model may include a neural network, and/or a neural network may be a specialized type of AI model.

The term “personalized AI model” is used herein to refer to an AI system or framework that is tailored to user preferences, behaviors, or specific requirements. A personalized AI model may use user-specific data to improve the accuracy and relevance of the AI model to the user. A personalized AI model may modify its responses or actions based on the accumulated insights. Personalized AI models may be particularly useful in applications such as personalized recommendations, adaptive learning systems, user-specific content delivery, and other systems in which it is beneficial for an AI model to make decisions based on a deep understanding of individual user profiles.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process performed at runtime or during the execution of the software application program corresponding to the neural network. In some embodiments, inference may include processing inputs using components of an adapter decomposed into secure fragments and operated within a secure execution environment (SEE). This secure processing may include traversing the processing nodes of the neural network along a forward path to produce one or more values, resulting in an overall activation or “inference result.” In some embodiments, the inference results derived from sensitive data may be processed within the SEE and securely transmitted back to an unsecured execution environment (UEE) (or normal world) for further processing or user interaction.

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in between the input and final layer may be referred to as intermediate layers, hidden layers, or black-box layers.

Each layer in a neural network may have multiple inputs and, thus, multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “adapter” is used herein to refer to a component of a neural network that allows the neural network to dynamically adjust its functionality without significant modifications or retraining. In some embodiments, the adapter may be an “adapter layer” in the neural network that allows for updating the behavior of an AI model based on new user data or objectives. In some embodiments, the adapter may be a modular component that may be added, removed, or modified independently of other parts of the neural network. In some embodiments, the adapter may include decomposed weight matrices that are derived from an original AI model and/or that allow for targeted modifications or enhancements without retraining the entire network. In some embodiments, the adapter may be configured to manage data processing and storage on a device so that sensitive information is handled securely within a trusted environment and less sensitive data is processed in a less secure but more computationally robust environment.

The term “embedding layer” is used herein to refer to a specialized layer within a neural network, typically at the input stage, that transforms discrete categorical values or tokens into continuous, high-dimensional vectors. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “lower-rank matrices” is used herein to refer to information structures that represent complex high-dimensional vectors and data in a simplified form with fewer dimensions or components. A processing system may generate and use lower-rank matrices to focus its operations on the most important or impactful elements. The simplification may be accomplished by using various known techniques that reduce the complexity of data while preserving important information, such as singular value decomposition (SVD) or principal component analysis (PCA). In addition, lower-rank matrices may help mitigate various other technical challenges, such as overfitting, by reducing the noise and redundancy in the data. Lower-rank matrices may also be used for other machine learning techniques, including dimensionality reduction and feature extraction, to overcome technical challenges associated with high-dimensional data spaces.

The term “token” is used herein to refer to a unit of information that an AI model may read as a single input during training and inference. Each token may represent any of a variety of different data types. Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 3000 dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc.

Some embodiments may include a processor or processing system configured to perform weight decomposition on AI model weights to produce simpler, lower-rank matrices (sometimes labeled U, V, and Σ). In some embodiments, the processing system may be configured to decompose the weight parameters of an AI model into lower-rank matrices that represent a diagonal matrix containing the singular values of the weight matrix W. This decomposition may allow for the division of the model into a secure component (e.g., the “adapter,). The adapter may be securely stored and operated within an encrypted memory in a secure environment. In some embodiments, the processing system may be configured to generate decomposed matrices that include learnable components, which may be fine-tuned on non-sensitive tasks or data.

In some embodiments, the processing system may be equipped with one or more multi-core processors capable of handling large-scale data operations and performing decomposition operations. In some embodiments, the processing system may use singular value decomposition (SVD), principal component analysis (PCA), or any other suitable method known in the art to simplify the model weights into the component matrices. In some embodiments, each matrix may serve a distinct function. For example, matrix U and matrix V may handle less sensitive data, whereas matrix Σ may be designated for handling more private or sensitive data.

In some embodiments, the processing system may be configured to integrate the adapter into the AI model or neural network. This integration may involve identifying target locations within the AI model in which the decomposed adapter matrices may be inserted. In some embodiments, the processing system may add these matrices into the appropriate network layers of the AI model. In some embodiments, the processing system may isolate the Σ matrix from less secure execution/processing environments to handle sensitive data more securely. In some embodiments, the adapter may represent or characterize the personalized component of the AI model and may be further segmented into secure fragments that allow for operation in both the UEEs and SEEs while maintaining privacy and enhancing performance.

In some embodiments, the processing system may be configured to perform dual-world operations in which the less sensitive components of the AI model (e.g., matrices U and V) operate in the UEE and the more sensitive component (Σ) operate within SEE. In some embodiments, inputs processed in the SEE may yield results that are transferred back to the UEE for subsequent operations. The processing system may use encrypted communication channels to ensure secure data transfer between the UEE and the SEE.

In some embodiments, the processing system may be configured to use a random matrix in computations within the UEE to obfuscate operations and enhance privacy. For example, the processing system may generate a random matrix of appropriate dimensions multiplied by the input data before processing it to disguise the data and make it difficult for unauthorized parties to interpret or misuse the data. In response to determining that the data has been transferred to the SEE for further processing or for generating inference results, the processing device may perform a reverse operation using the inverse or a pre-determined key associated with the random matrix to recover the original data.

In some embodiments, the processing system may be configured to relay gradients (e.g., quantitative measures of error reduction in the parameters of the AI model, etc.) from the UEE to the SEE to update the decomposed adapter, send the resulting gradients back to the UEE for full model backpropagation. For example, the processing system may compute the gradients based on training data processed in the UEE, securely encrypt the gradients, and send the encrypted gradients to the SEE, use the gradients in the SEE to update important elements of the decomposed adapter that handle sensitive data within the SEE, encrypt the adjusted gradients or updated model parameters, and send the encrypted gradients/parameters back to the UEE. The processing system may use this information in UEE to perform backpropagation across the entire network so that the updates made in the SEE are integrated into the overall model.

In some embodiments, the processing system may be configured to encrypt the personalized part using a device-specific key before being saved to the flash memory. In some embodiments, the processing system may load and decrypt the data within the secure environment so that the information remains secure even if the physical memory is compromised. For example, the processing system may encrypt the personalized adapter data using a cryptographic key generated or derived based on device-specific attributes (e.g., the device hardware configuration, a unique identifier, etc.), and store the encrypted data in a secure flash memory. In response to detecting a request to access the personalized data, the processing system may load the encrypted data from the flash memory into the SEE and decrypt the loaded data using the same or a corresponding decryption key securely stored or regenerated within the SEE. As a result, the data may be accessible only within the SEE.

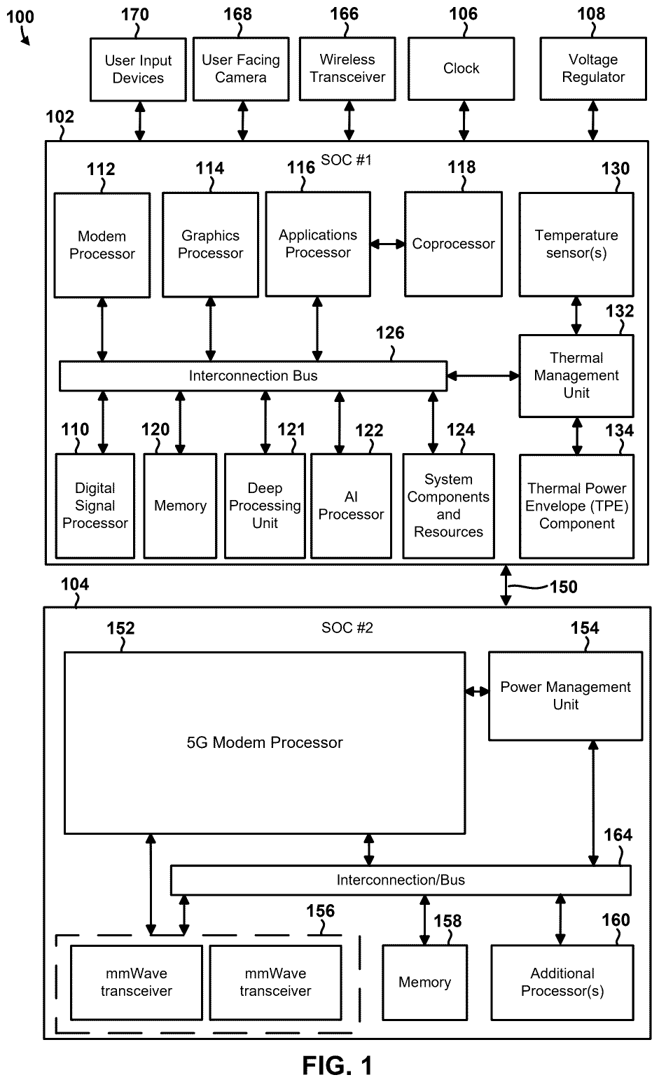

Various embodiments may be implemented on a number of single-processor and multiprocessor computer systems, including a system-on-chip (SOC) or SIP. FIG. 1 illustrates an example computing system or SIP 100 architecture that may be used in computing devices implementing various embodiments.

With reference to FIG. 1, the illustrated example SIP 100 includes two SOCs 102, 104, a clock 106, a voltage regulator 108, a wireless transceiver 166, a user facing camera 168 and user input devices 170 (e.g., a touch-sensitive display, a touch pad, a mouse, etc.). The first and second SOC 102, 104 may communicate via interconnection bus 150. Various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any, or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, data processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any, or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the computing device. In addition, any, or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as the clock 106, the voltage regulator 108, the wireless transceiver 166 (e.g., cellular wireless transceiver, Bluetooth transceiver, etc.), the user facing camera 168 and user input devices 170 (e.g., a touch-sensitive display, a touch pad, a mouse, etc.). Resources external to the SOC (e.g., clock 106, voltage regulator 108, wireless transceiver 166) may be shared by two or more of the internal SOC processors/cores. Further, the first and/or second SOCs 102, 104 may be configured with modules for processing data received from the user facing camera 168 and user input devices 170 to track a user's attention as described herein.

In addition to the example SIP 100 discussed above, various embodiments may be implemented in various computing systems, including a single processor, multiple processors, multicore processors, or any combination thereof.

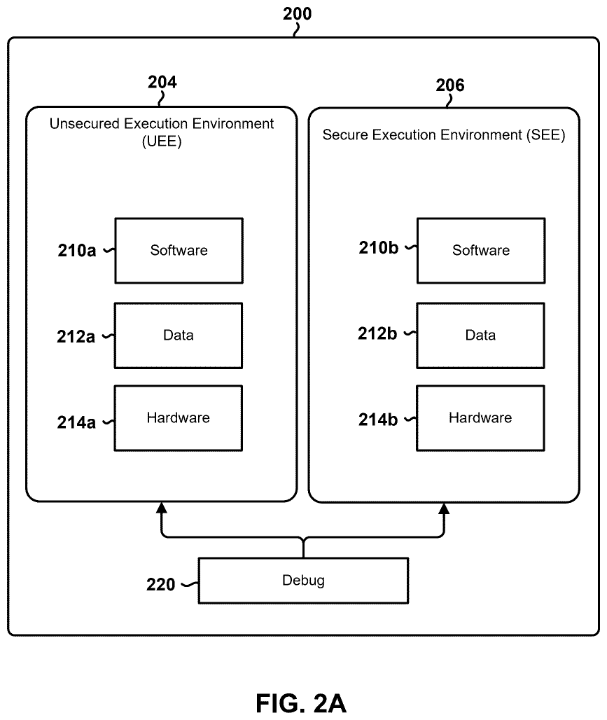

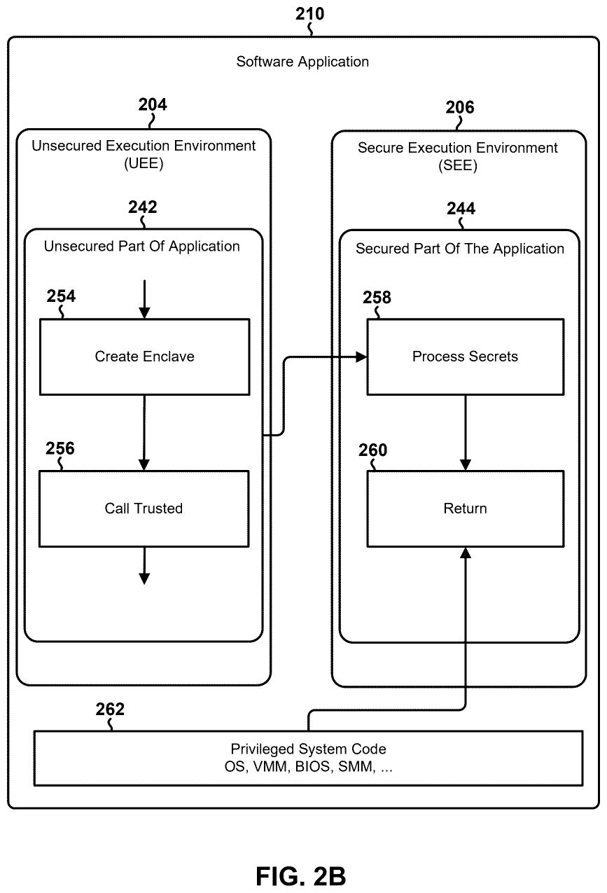

FIGS. 2A and 2B illustrate secure computing devices that could be configured to prevent leakage in personalized AI models via weight decomposition in accordance with some embodiments. With reference to FIGS. 1-2A, a computing device 200 (e.g., computing device 100, etc.) may include an unsecured execution environment (UEE) 204 and a secure execution environment (SEE) 206, each of which may include software 210a, 210b, data 212a, 212b, and hardware 214a, 214b. The computing system 200 may also include a debug 220 component with access to the UEE 204 and SEE 206. The debug 220 component may be configured for tracing and rectifying issues across both environments. As such, the debug 220 component may also be used to help ensure that sensitive computations related to weight decomposition and the operation of the AI model's secure adapter are isolated within the SEE 206.

With reference to FIGS. 1-2B, the computing device 200 may include a software application 210 that includes an unsecured part 242, a secured part 244, and privileged system code 262. In the example illustrated in FIG. 2B, the unsecured part 242 of the application may include logic and functionalities to generate a secure enclave 254 that establishes a protected area within the SEE and to invoke or call trusted functions 256 within the protected area. The secured part 244 of the application may be configured to handle sensitive operations such as processing secrets 258 within the enclave so that all sensitive data manipulations remain confined to this secure area. The return component 260 may be configured to manage the output from these operations back to the unsecured part or external systems as necessary. In addition, application 210 may interact with privileged system code 262 (e.g., the operating system, BIOS, virtual machine monitors (VMM), etc.) that oversees and manages the higher-level security and operational protocols of device 200.

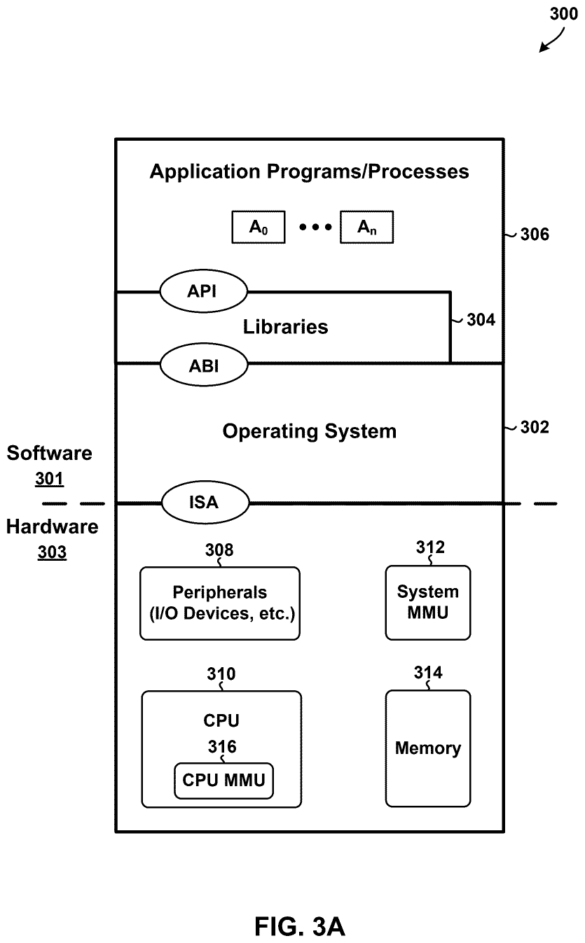

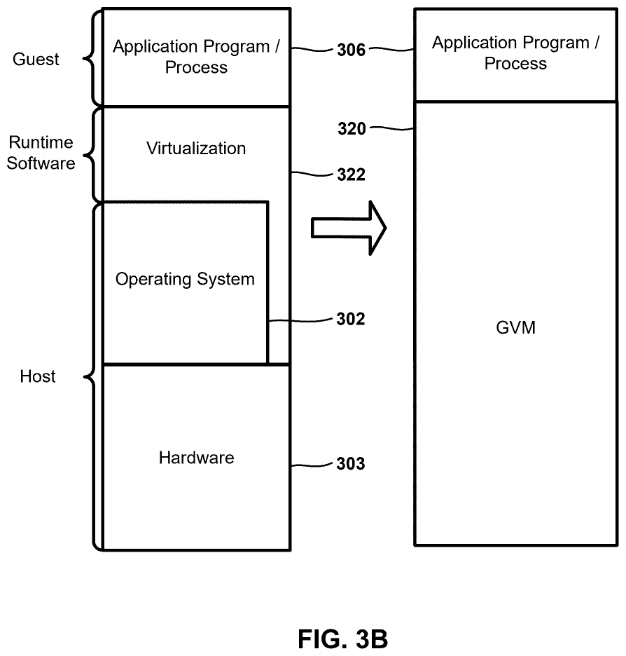

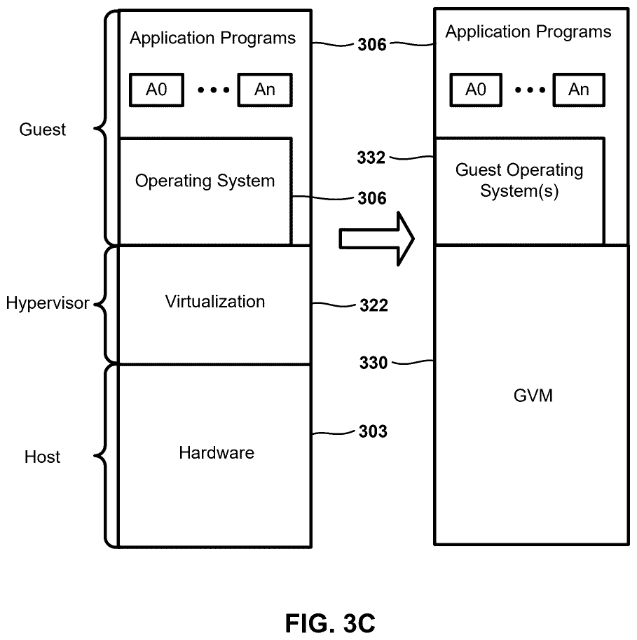

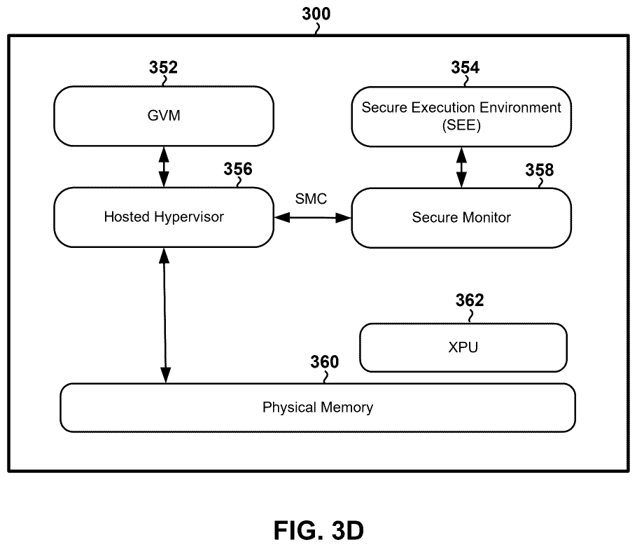

FIGS. 3A-3D illustrate additional example computing architectures that could be used to perform weight decomposition to improve personalized AI models in accordance with some embodiments. With reference to FIG. 1-3A, a layered computer system architecture 300 may include both software components 301 (e.g., software applications 210, etc.) and hardware components 303 (e.g., processors 110, 112, 114, 116, 118, 121, 122, 121, 122, 152, 160, 180, etc.). The software components 301 may include an operating system 302, a library module 304, and one or more application programs (A₀ through Aₙ) 306. The hardware components 303 may include peripherals 308 (e.g., hardware accelerators, input/output devices, etc.), a central processing unit (CPU) 310, a central processing unit memory management unit (CPU MMU) 316, one or more system memory management units (herein “system MMU” or “SMMU”) 312, and one or more memories 314.

Application software written for computing devices may be compiled into executable code, commonly called “applications,” “apps,” software applications 210, or application programs 306. Each application program 306 may be a single process or thread or may include a plurality of processes or threads.

Application programs 306 (e.g., software applications 210, etc.) may issue high-level language (HLL) library calls to the library module 304 via an application program interface (API). The library module 304 may invoke services (e.g., via operating system calls) on the operating system 302 via an application binary interface (ABI). The operating system 302 may communicate with the hardware components using a specific instruction set architecture (ISA), which lists specific operation codes (opcode) and native commands implemented by the hardware 303. In this manner, the instruction set architecture may define the hardware 303 as seen by the operating system 302.

The operating system 302 may coordinate and control the allocation and use of the various memories 314 amongst the application programs 306, which may include partitioning the physical memory across the multiple application programs (A0-An) 306. In an embodiment, the operating system 302 may include one or more memory management systems (e.g., a virtual memory manager, etc.) for managing the allocation and use of system memory by the various application programs (A₀ through Aₙ) 306. Memory management systems may function to ensure that the memory used by one process does not interfere with memory already in use by another process.

In an embodiment, the operating system 302 may include a virtual memory manager (OS VMM) configured to perform “virtual addressing” operations that enable the operating system 302 to make a particular physical address appear to be another address (i.e., a virtual address). The virtual addressing operations may include allocating virtual memory address to the application programs (A₀-Aₙ) 306. Including a virtual memory manager within the operating system 302 may simplify the coordination and control of the system memory among the multiple processes or application programs (A₀-Aₙ) 306.

In addition to the software-based memory management systems (e.g., OS VMM, etc.) discussed above, the system may include one or more hardware-based memory management systems, such as the CPU memory management unit (MMU) 316 and the system MMU 312. The CPU MMU 316 and the system MMU 312 may each include one or more hardware components responsible for performing various memory related operations, such as translating virtual addresses to physical addresses, cache control, bus arbitration, and memory protection. In an embodiment, the CPU MMU 316 may be responsible for providing address translation services and protection functionalities to the main CPU 310, and the system MMU 312 may be responsible for providing address translation services and protection functionalities to other hardware components (e.g., digital signal processor, modem processor, graphics processor, etc.).

In various embodiments, one or more of the memory management systems (e.g., system MMU 312, CPU MMU 316, etc.) may include a translation look-aside buffer (TLB), which is a cache memory that may be used for memory address translations (e.g., translating virtual addresses to physical addresses, etc.). In an embodiment, the TLB may be a content-addressable memory (CAM), which may be a hardware associative array memory in which stored information is organized into key-value format (e.g., hash table). The keys may be virtual addresses and the values may be physical addresses.

Some processor systems only support a single stage of the memory address translation process and require the hypervisor to manage the relationship between virtual addresses, intermediate physical addresses, and physical addresses. This is generally achieved by the hypervisor maintaining its own translation tables (called shadow translation tables), which may be derived by interpreting each of the guest operating system's translation tables. On such systems, the hypervisor ensures that all changes to the guest operating system's translation tables are reflected in the shadow structures, as well as enforce protections and redirecting access faults to the appropriate stage.

Some processor systems provide hardware assistance for both stages of memory translation. For example, ARM processors may include Virtualization Extensions that enable the guest operating system to translate the virtual addresses to intermediate physical addresses in a first stage (i.e., first stage translations), and for hardware to translate the intermediate physical addresses to physical addresses in a second stage (i.e., second stage translations). Such Virtualization Extensions reduce the overheads associated with executing, maintaining, and/or managing the hypervisor, and improve computing device performance.

Various embodiments may utilize virtualization techniques. Virtualization technologies enable the abstraction (or virtualization) of computing resources, which may be achieved by placing a control program (e.g., a Virtual Machine Monitor “VMM” or hypervisor) between the operating system and the hardware. Virtualization techniques are commonly implemented in a virtual machine (VM), which may be a software application that executes application programs like a physical hardware machine. Virtual machines may be categorized into two general categories: system virtual machines and process virtual machines. System virtual machines allow the sharing of the underlying physical hardware between different processes or applications. Process virtual machines, on the other hand, may support a single process or application.

FIG. 3B is a layered architectural diagram illustrating the logical layers in a computing device implementing a process virtual machine. With reference to FIG. 1-3B, the virtualization component 322 may be a software component that runs on the hardware 303 and/or on top of the operating system 302 to emulate the hardware ISA and/or to otherwise provide the application programs with virtualized hardware resources. As discussed above, hardware components are only visible to the application programs 306 through the operating system 302, and the ABI and API effectively define the hardware features available to the application programs 306. As such, the virtualization component 322 may perform logical operations at the ABI/API level and/or emulate operating system calls or library calls such that the application programs 306 communicate with the virtualization component 322 in the same manner they would otherwise communicate with hardware components (i.e., via system/library calls). In this manner, the application programs 306 view the combination of the virtualization component 322, operating system 306, and hardware 308 as a single machine, such as the guest virtual machine (GVM) 320 illustrated in FIG. 3B. This simplifies the job of the application developer since application software need not be concerned with the actual architecture of computing devices on which the application will ultimately execute.

The GVM 320 illustrated in FIG. 3B exists solely to support a single application program 306. As such, it is created with the application program 306 and terminated when the application program 306 finishes execution. An application program 306 that runs on the virtual machine is called the “guest” and the underlying platform is called the “host.” Virtualization software 304 that implements the process virtual machine is typically called runtime software (or simply “runtime”).

FIG. 3C is a layered architectural diagram illustrating the logical layers in a computing device implementing a system virtual machine. With reference to FIG. 1-3C, the computer system may include hardware components (e.g., execution hardware, memory, I/O devices, etc.) 303 and software components that include an application programs 306, an operating system 306, and a virtualization component 322. Software that runs on top of the virtualization component 322 is referred to as “guest” software and the underlying platform that supports the virtualization module is referred to as “host” hardware.

Unlike process virtual machines, a system virtual machine provides a complete environment on which multiple guest operating systems 332 may coexist. Likewise, the host hardware platform may be configured to simultaneously support multiple, isolated guest operating system environments. The isolation between the concurrently executing operating systems adds a level of security to the system. For example, if security on one guest operating system is breached, or if one guest operating system suffers a failure, the software running on other guest systems is not affected by the breach/failure. The host hardware platform also simplifies the job of the application developer since application software need not be concerned with the actual architecture of computing devices on which the application will ultimately execute.

In the example illustrated in FIG. 3C, the virtualization component 322 is logically situated between the host hardware and the guest software. The virtualization component 322 may run on the actual hardware (native) or on top of an operating system (hosted), and is typically referred to as a “hypervisor” or virtual machine monitor (VMM). In native configurations, the virtualization component 322 runs on the actual hardware in the highest privilege mode available, and the guest operating systems 332 run with reduced privileges such that the virtualization component 322 can intercept and emulate all guest operating system actions that would normally access or manipulate the hardware resources. In hosted configurations, the virtualization component 322 runs on top of an existing host operating system 302, and may rely on the host operating system 302 to provide device drivers and other lower-level services. In either configuration (native or hosted), the guest operating systems 332 communicate with the virtualization component 322 in the same manner they would communicate with the physical hardware 303, viewing the combination of the virtualization component 322 and hardware 303 as a single guest virtual machine (GVM) 330. This allows each guest operating system 332 to operate under the illusion of having exclusive access to processors, peripherals, I/O, MMUs, and memories in the hardware 303.

FIG. 3D illustrates a computing system 300 that includes a GVM 352, a secure execution environment 354 (e.g., ARM TrustZone®), a hosted hypervisor 356, a security monitor 358, and physical memory 360. In some embodiments, the computing system 300 may also include a Cross-Privilege-Unit (XPU) 362.

The hosted hypervisor 356 may facilitate the mapping of intermediate physical addresses (IPA) maintained by the GVM 352 to physical addresses (PA) in the physical memory 360, and otherwise act as an intermediary between the GVM 352 and the physical memory 360 or other hardware 303.

To ensure the security and isolation of the GVM 352, it is often necessary to use a secure monitor 358 to manage certain sensitive operations. One such operation is the sharing of memory between the GVM 352 and the secure execution environment 354. The secure monitor 358 may be invoked through a special instruction known as a secure monitor call (SMC). The SMC allows the GVM 352 to request access to the secure execution environment memory or to perform other sensitive operations, such as accessing cryptographic keys or controlling hardware peripherals. The SMC is typically only accessible to the secure monitor 358, so it serves as a gatekeeper to ensure that only trusted code can access the secure execution environment and its resources.

Thus, the SMC and security monitor 358 may operate as a gatekeeper, ensuring only secure data enters and exits the secure execution environment 354. The use of SMC and the secure monitor 358 allows for the secure communications and the sharing of memory between the GVM 352 and the secure execution environment 354, helping to ensure the security and integrity of both environments.

An XPU 362 may operate to help protect the processor and system against security vulnerabilities and attacks by enforcing privilege and memory isolation. An XPU is a hardware feature in some SOCs that may be used to enforce security boundaries, such as between the secure and normal worlds 354. The XPU may accomplish this by preventing the normal world from accessing certain resources (e.g., buffers, registers, etc.) that should only be accessible to the secure world. These resources include buffers used to temporarily store data during processing. Locking the buffers via the XPU 362 during processing helps to ensure that sensitive data in the secure world (e.g., secure execution environment 354) is protected from tampering or exploitation by processes in the normal world (e.g., GVM 352).

An XPU lock may be used to protect shared resources from being accessed simultaneously by different privilege levels (e.g., user mode, supervisor mode, etc.). Said another way, a XPU lock may be used to prevent multiple privilege levels from accessing a shared resource at the same time. For example, the computing system 300 configured to identify a shared resource (e.g., buffer) that needs to be protected, determine the privilege level(s) that should be allowed to access the shared resource, and use XPU lock instructions to set the XPU lock for the shared resource. Using XPU lock instructions may include using a memory coprocessor register (MCR) instruction to write to a coprocessor register in the system coprocessor (CP15). The computing system 300 may then access the shared resource using the appropriate privilege level. When the access to the shared resource is complete, the computing system may use the XPU lock instructions to release the lock.

While an XPU lock is effective in preventing simultaneous access to a shared resource from different privilege levels, it may not prevent multiple accesses from the same privilege level. Protection against simultaneous access from the same privilege level may be accomplished by the computing system 300 using other synchronization mechanisms (e.g., mutexes, semaphores, etc.).

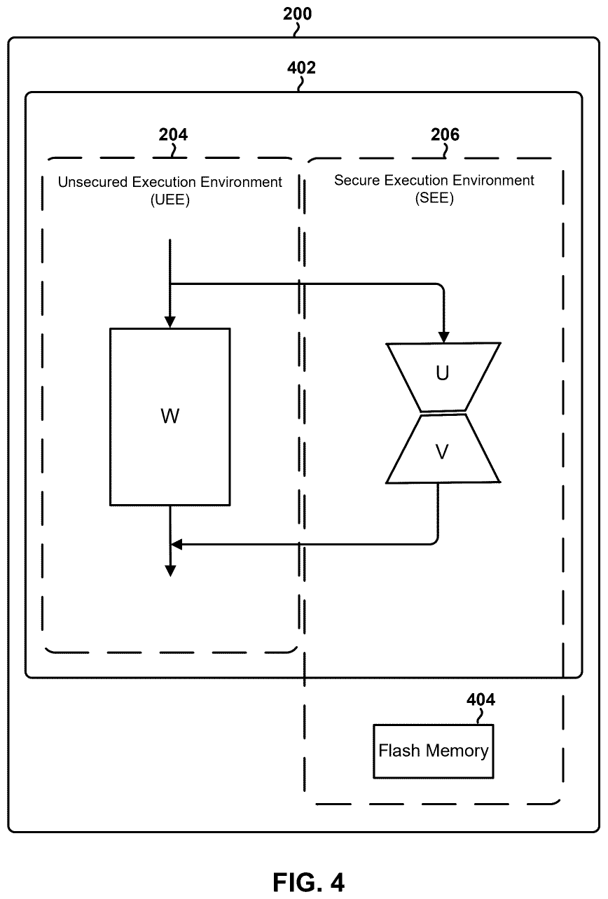

FIG. 4 illustrates components and operations in a computing system 200 that includes an AI model 402 configured in accordance with some embodiments. With reference to FIGS. 1-4, computing system 200 may include a flash memory 404 within the SEE 206 that could be used for storing data (e.g., the sensitive components of the AI model) in an encrypted format. A processing system in the computing system 200 may include, use, and/or apply the model weights (W) of the AI model 402 in the UEE 204 without specialized security measures. The processing system may decompose the original model weights (W) to generate lower-rank matrices (U and V) and include, use, and/or apply the generated lower-rank matrices (U and V) within the SEE 206.

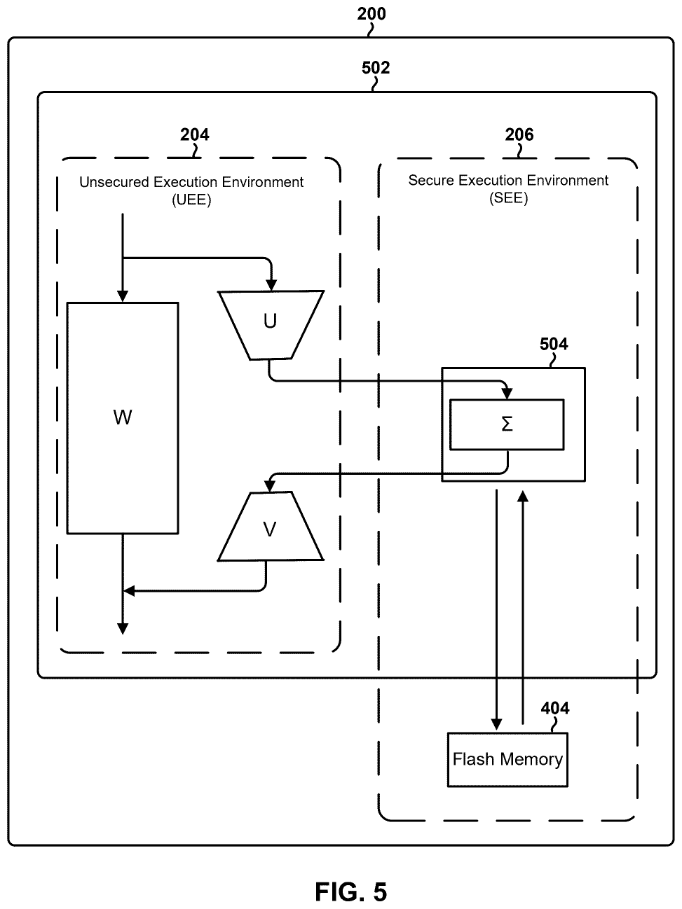

FIG. 5 illustrates components and operations in a computing system 200 that includes another AI model 502 configured in accordance with some embodiments. With reference to FIGS. 1-5, a processing system in the computing system 200 may include, use, and/or apply the model weights (W) of the AI model 402 in the UEE 204 without specialized security measures. The processing system may perform weight decomposition on model weights (W) to produce simpler lower-rank matrices U, V, and Σ. In some embodiments, the processing system may be configured to generate any or all of the lower-rank matrices U, V, and Σ so that they represent a diagonal matrix containing the singular values of a weight matrix. This decomposition may allow for the division of the AI model into a secure adapter 504 component. The adapter 504 may be securely stored and operated within an encrypted memory in the SEE 206.

In some embodiments, the processing system may be configured to generate the lower-rank matrices U, V, and Σ so that each matrix serves a distinct function. For example, matrix U and matrix V may handle less sensitive data, whereas matrix Σ may be designated for handling more private or sensitive data.

In some embodiments, the processing system may be configured to integrate the adapter 504 into the AI model 502 by performing operations that include identifying target locations within the AI model 502 in which the decomposed adapter matrices (e.g., Σ, etc.) may be inserted. In some embodiments, the processing system may add these matrices into the appropriate network layers of the AI model. In some embodiments, the processing system may isolate the adapter 504 or the Σ matrix from the UEE 204.

In some embodiments, the adapter 504 may represent or characterize the personalized component of the AI model 502. In some embodiments, the AI model may be further segmented into secure fragments that allow for operation in both the UEE 204 and SEE 502 while maintaining privacy and enhancing performance.

In some embodiments, the processing system may be configured to perform dual-world operations in which the less sensitive components of the AI model (e.g., matrices U and V) operate in the UEE 204 and the more sensitive components (e.g., matrix Σ) operate within SEE 206. In some embodiments, inputs processed in the SEE 206 may yield results that are transferred back to the UEE 204 for subsequent operations. The processing system may use encrypted communication channels to ensure secure data transfer between the UEE 204 and the SEE 206.

In some embodiments, the processing system may be configured to use a random matrix in computations within the UEE to obfuscate operations and enhance privacy. In response to determining that the data has been transferred to the SEE for further processing or for generating inference results, the processing device may perform a reverse operation using the inverse or a pre-determined key associated with the random matrix to recover the original data.

In some embodiments, the processing system may be configured to encrypt the personalized part of the data using a device-specific key before saving it to the flash memory 404. In some embodiments, the processing system may load and decrypt the data within the SEE 206 so that the personalized information remains secure even if the physical memory is compromised. For example, the processing system may encrypt the personalized data of the adapter 504 using a cryptographic key that is generated or derived based on device-specific attributes (e.g., the device hardware configuration, a unique identifier, etc.), and store the encrypted data in the flash memory 404. In response to detecting a request to access the personalized data, the processing system may load the encrypted data from the flash memory 404 into the SEE 206 and decrypt the loaded data using the same or a corresponding decryption key securely stored or regenerated within the SEE 206 (i.e., the data may be accessible only within the SEE 206).

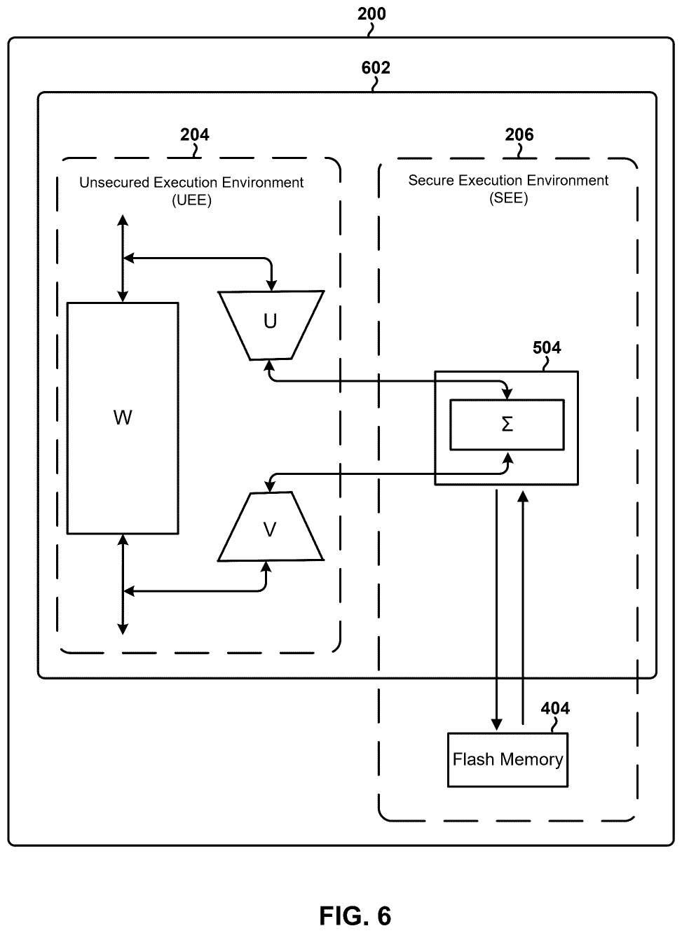

FIG. 6 illustrates components and operations in a computing system 200 that includes an AI model 602 configured to perform backpropagation in accordance with some embodiments. With reference to FIGS. 1-6, the computing system 200 and AI model 602 include all the components discussed above with reference to FIG. 5. In this example, the processing system may be configured to relay gradients (e.g., quantitative measures of error reduction in the parameters of the AI model, etc.) from the UEE 204 to the SEE 206 to update the adapter 504 and send the resulting gradients back to the UEE 204 for full model backpropagation. For example, the processing system may compute the gradients based on training data processed in the UEE 204, securely encrypt the gradients, and send the encrypted gradients to the SEE 206, use the gradients in the SEE 206 to update important elements of the adapter 504 that handle sensitive data within the SEE 206, encrypt the adjusted gradients or updated model parameters, send the encrypted gradients/parameters back to the UEE 204, and use the updated gradients/parameters in UEE 204 to perform backpropagation across the entire network and/or so that the updates made in the SEE 206 are integrated into the overall AI model 602.

In some embodiments, the synchronization between the SEE and UEE is managed to maintain efficiency across both environments. Non-sensitive computations involving matrices U and V occur in the UEE, while sensitive computations involving matrix Σ take place within the SEE. Additionally, training the AI model may involve using matrices U and V for non-sensitive training data in the UEE and matrix Σ for sensitive training data in the SEE.

In some embodiments, the system is designed to be scalable and adaptable, allowing for the integration of new adapters without extensive modifications. This flexibility supports the secure and efficient operation of AI models, particularly in applications requiring robust security measures, such as personalized AI models. This design strategy facilitates a dual-world operation that enhances data security while ensuring that the AI model's performance and functionality are not compromised.

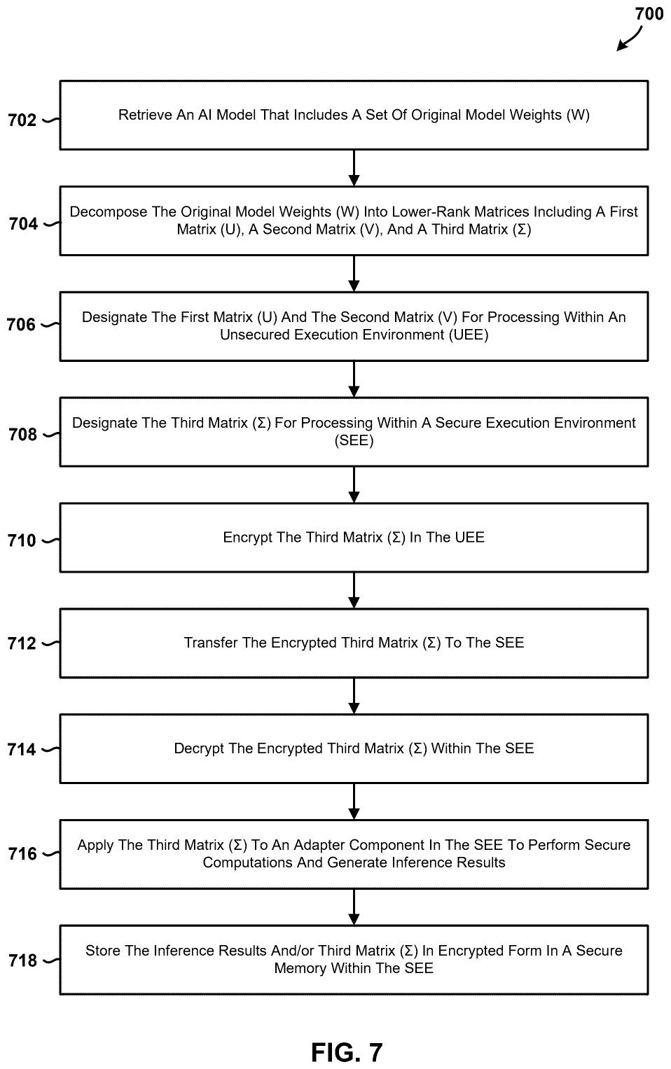

FIGS. 7-9 are process flow diagrams illustrating methods 700, 800, 900 of performing weight decomposition and securing artificial intelligence (AI) models in accordance with some embodiments. With reference to FIGS. 1-9, the methods 700, 800, 900 may be performed in a computing device by a processing system encompassing at least one processor (e.g., 110, 112, 114, 116, 118, 121, 122, 121, 122, 152, 160, 180, etc.) coupled to memory (e.g., 120, 158, etc.), and other components or subsystems discussed in this application. Means for performing the functions of the operations in the methods 700, 800, 900 may include a processing system including at least one processor 110, 112, 114, 116, 118, 121, 122, 121, 122, 152, 160, 180, coupled to memory (e.g., 120, 158, etc.), and other components described herein. Further, at least one processor of a processing system may be configured with software or firmware to perform some or all of the operations of the methods 700, 800, 900. In order to encompass the alternative configurations enabled in various embodiments, the hardware implementing any or all of the methods 700, 800, 900 is referred to herein as “at least one processor.”

For the sake of clarity and ease of presentation, methods 700, 800, 900 are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. to produce a modified or alternative result or solution. The presentation of individual methods, blocks, operations, etc. should not be interpreted as mutually exclusive, limiting, or as being required unless expressly recited as such in the claims.

With reference to FIGS. 1-7, in block 702 of the method 700 the at least one processor may retrieve an AI model that includes original model weights (W). In some embodiments, the operations in block 702 may be performed by a first processor in an unsecured execution environment (UEE). The original model weights (W) may be stored in various formats and locations, such as in a cloud-based storage system, local database, or directly embedded within the application. Examples of retrieved model weights (W) include, but are not limited to, weights from fully connected layers, convolutional layers, or recurrent layers of a neural network. The original model weights (W) may be numerical values that have been previously trained to perform specific tasks (e.g., image recognition, predictive analytics, etc.) and may collectively form core computational parameters that define the behavior of the AI model.

In block 704, the at least one processor may decompose the original model weights (W) into lower-rank matrices that include a first matrix (U), a second matrix (V), and a third matrix (Σ). In some embodiments, the third matrix (Σ) may be a diagonal matrix that includes singular values of the original model weights (W). These singular values may be derived from the decomposition operations that identify sensitive, private, or personal data characteristics or features. A diagonal matrix is a type of square matrix in which all entries outside the main diagonal are zero. The main diagonal itself may include either zero or non-zero elements. The structure of a diagonal matrix simplifies many matrix operations by reducing the number of calculations or computations. This may in turn improve the performance and/or power consumption characteristics of the computing device or application.

The singular values within matrix Σ may quantify the significance of data dimensions from the original matrix (W), with each singular value representing the strength or prevalence of a particular feature. These values are generally non-negative real numbers that offer insights into data feature distribution and importance. For example, high singular values often correlate with dimensions possessing strong feature presence or high variability. As such, the at least one processor may use these values to prioritize important features during processing.

In some embodiments, at least one processor may use a decomposition algorithm in block 704 to decompose the original model weights (W) into lower-rank matrices. In some embodiments, the operations in block 704 may be performed by the first processor in the UEE. Examples of decomposition algorithms include, but are not limited to, singular value decomposition (SVD), principal component analysis (PCA), and Quotient-Remainder (QR) factorization. For example, the at least one processor may apply SVD to decompose the high-dimensional weight matrix (W) into the matrices U, Σ, and V, where U and V are orthogonal matrices and Σ contains the singular values. As another example, the at least one processor may use SVD to separate the weight matrix (W) into orthogonal matrices U and V, and a diagonal matrix Σ that holds the singular values. These decomposition operations may characterize the data in fewer dimensions and/or isolate the most personal or significant values (e.g., for inclusion in third matrix (Σ), etc.).

In block 706, the at least one processor may designate the first matrix (U) and the second matrix (V) for processing within an unsecured execution environment (UEE). For example, the at least one processor may analyze or evaluate the security needs of the data involved with the matrices and determine that the first and second matrices do not include personal information (or that there is a low probability of the data including personal information, etc.). In response, the at least one processor may use the robust resources (e.g., computational power, etc.) available in the UEE for intensive operations such as matrix manipulations and data transformations for many of the data processing tasks. In some embodiments, the operations in block 706 may be performed by the first processor in the UEE.

In block 708, the at least one processor may designate the third matrix (Σ) for processing within a secure execution environment (SEE). In some embodiments, the operations in block 708 may be performed by the first processor in the UEE. For example, at least one processor may determine that the third matrix includes sensitive, private, or personal data characteristics that require or would benefit from enhanced security measures and initiate protocols to ensure that all computations involving matrix Σ occur exclusively in the SEE where security controls are more stringent. In some embodiments, designating the third matrix (Σ) as the secure component for processing within the SEE may include encrypting and storing the third matrix (Σ) in encrypted form in the secure memory within the SEE. In some embodiments, these operations may include restricting access to the data, using advanced encryption methods, and using secure hardware components designed to prevent unauthorized data exposure or breaches.

In block 710, the at least one processor may encrypt the third matrix (Σ) in the UEE. In some embodiments, the operations in block 710 may be performed by the first processor in the UEE. For example, the processor may use a symmetric encryption algorithm, such as Advanced Encryption Standard (AES), to obtain a high-level of security while maintaining efficient processing speeds. The encryption may include generating and using a unique encryption key to encrypt the third matrix (Σ) and converting its sensitive data into a cipher format that is challenging to decipher without the corresponding decryption key. The processor may also apply a hashing function to the encrypted data to create a digest that may be used to verify the integrity of the data upon decryption.

In block 712, the at least one processor may transfer the encrypted third matrix (Σ) to the SEE. In some embodiments, the processor may package the encrypted matrix (Σ) and its integrity hash into a data packet that is structured to enhance security during transmission or transfer to the secure zone. In some embodiments, the operations in block 712 may be performed by the first processor in the UEE.

In block 714, the at least one processor may receive and decrypt the encrypted third matrix (Σ) within the SEE. In some embodiments, the operations in block 714 may be performed by a second processor in the SEE. For example, upon receipt of the encrypted data, the second processor within the SEE may retrieve a previously stored or dynamically generated decryption key from a secure key management system exclusive to the SEE. The decryption keys may remain isolated from less secure environments to improve data protection. The second processor may apply a decryption algorithm to convert the cipher format of the third matrix (Σ) back into its original readable form. During this decryption process, the second processor may also verify the integrity of the data using the hash included with the encrypted packet. This verification ensures that the data has not been altered or tampered with during transit.

The secure transfer and decryption of the third matrix (Σ) within the SEE in blocks 712 and 714 may provide a controlled setting with heightened security for sensitive data. These operations may also reduce the exposure of sensitive data to potential security vulnerabilities associated with broader system environments and/or may improve the efficiency of secure operations by limiting them to only the components that require or which most benefit from stringent security measures.

In block 716, the at least one processor may apply the third matrix (Σ) to an adapter component in the SEE to perform secure computations and generate inference results. In some embodiments, the operations in block 716 may be performed by the second processor in the SEE. For example, this adapter component may use the decrypted values from the third matrix (Σ) to alter, update, or fine tune the behavior of the AI model for specific tasks that require enhanced privacy and security, such as personalized data analysis or sensitive information processing. The adapter may use important attributes encoded in the third matrix to adjust or enhance the performance of the AI model in real-time. In some embodiments, the adapter component may transfer the generated inference results back to UEE or less secure environment. In some embodiments, applying the third matrix (Σ) to an adapter component may include integrating the third matrix with the adapter, which may include performing relatively complex mathematical operations, such as matrix multiplications or transformations. These operations may be performed in the SEE to prevent any possibility of sensitive data leakage.

In block 718, the at least one processor may store the inference results or third matrix (Σ) in encrypted form in a secure memory within the SEE. In some embodiments, the operations in block 718 may be performed by the second processor in the SEE. Examples of the stored inference results or third matrix (Σ) data include, but are not limited to, personalized user profiles used in targeted advertising, confidential financial records in fintech applications, or sensitive health information in medical diagnostics. Storing such data in an encrypted form within the secure memory of the SEE allows the system to maintain the integrity and confidentiality of the data even if an unauthorized or nefarious actor gains access to the memory or physical storage.

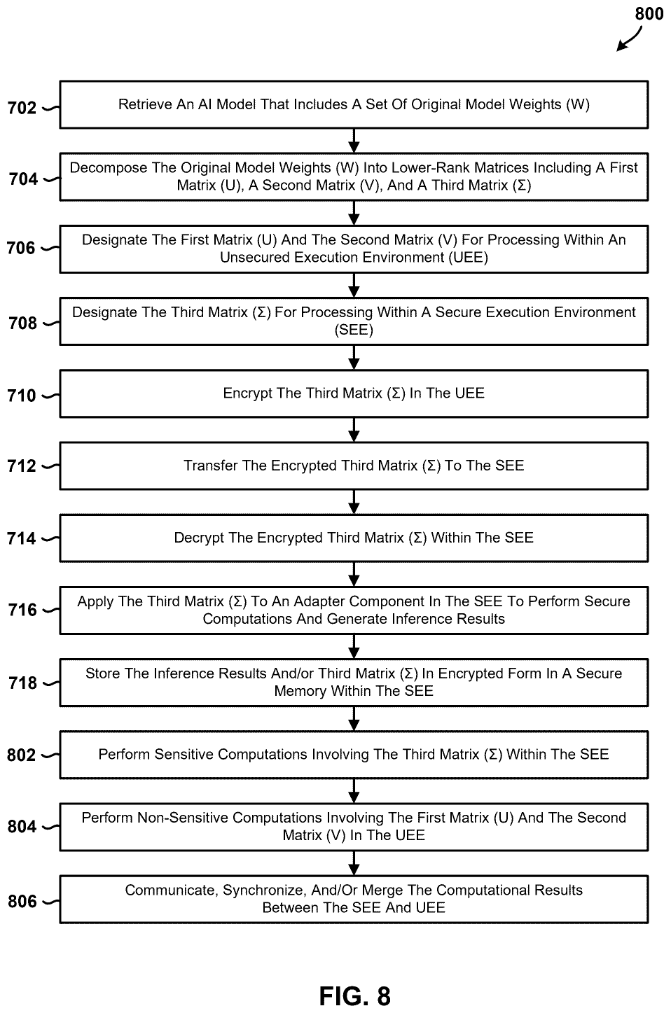

With reference to FIGS. 1-8, in blocks 702-718 the at least one processor may perform the same or similar operations discussed above with reference to blocks 702-718 and FIG. 7. In block 802 of method 800 illustrated in FIG. 8, the at least one processor may perform sensitive computations involving the third matrix (Σ) within the SEE. In some embodiments, the operations in block 802 may be performed by the second processor in the SEE. For example, the second processor may use components within the SEE to rapidly and securely process the encrypted data in matrix (Σ). Sensitive computations may include risk assessment operations that are performed based on personal financial data. The second processor may safeguard the data from potential breaches by processing such sensitive or personal information within the SEE.

In block 804, the at least one processor may perform non-sensitive computations involving the first matrix (U) and the second matrix (V) in the UEE. In some embodiments, the operations in block 804 may be performed by the first processor in the UEE. For example, the at least one processor may use the general computing capabilities of the UEE to handle less critical data processing tasks. The processor may use standard CPUs without the need for enhanced security measures.

In block 806, the at least one processor may communicate, synchronize, and/or merge the computational results between the SEE and UEE. For example, the at least one processor may use system calls or a secure data transfer protocol to transfer the data passed between the environments so that the data is not intercepted or altered. In some embodiments, the operations in block 806 may be performed by either or both of the first and/or second processor.

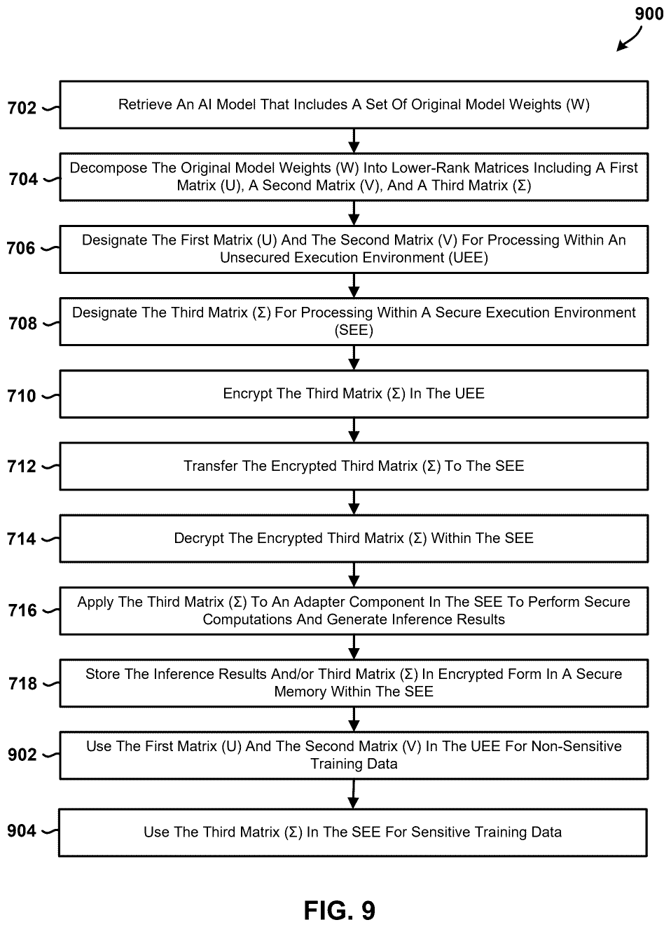

With reference to FIGS. 1-9, in blocks 702-718 the at least one processor may perform the same or similar operations discussed above with reference to blocks 702-718 and FIGS. 7 and 8. In block 902 of method 900 illustrated in FIG. 9, the at least one processor may train or retrain the AI model using the first matrix (U) and the second matrix (V) in the UEE for non-sensitive training data. For example, the processor may use a gradient descent algorithm to adjust the weights in matrices U and V based on the output errors when processing generic, non-personalized data, such as public datasets or anonymized user interactions. This allows the bulk of computationally intensive training operations to be offloaded to the UEE.

In block 904, the at least one processor may use the third matrix (Σ) in the SEE for sensitive training data. In some embodiments, the operations in block 904 may be performed by the second processor in the SEE. For example, the processor may use secure multi-party computation techniques and/or homomorphic encryption to perform computations on encrypted data in a secure environment.

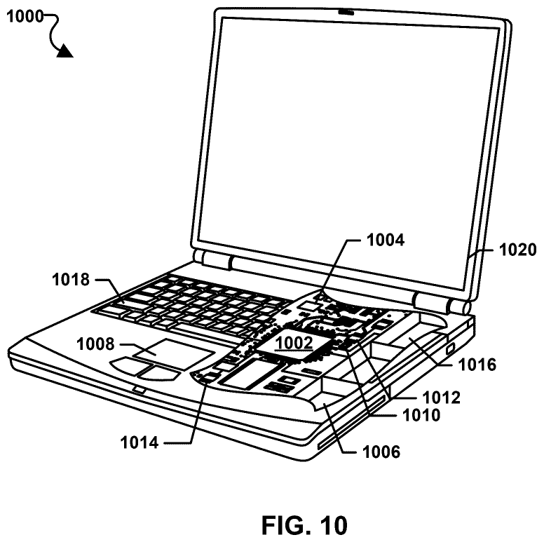

Various embodiments (including, but not limited to, embodiments described above with reference to FIGS. 1-9) may be implemented in a wide variety of wireless devices and computing systems including a laptop computer 1000, an example of which is illustrated in FIG. 10. With reference to FIGS. 1-10, a laptop computer may include a at least one processor 1002 coupled to volatile memory 1004 and a large capacity nonvolatile memory, such as a disk drive 1006 or Flash memory. The laptop computer 1000 may include a user-facing camera 168 coupled to the at least one processor 1002. The laptop computer 1000 may include a touchpad touch surface 1008 that serves as the computer's pointing device, and thus may receive drag, scroll, and flick gestures. Additionally, the laptop computer 1000 may have one or more antenna 1010 for sending and receiving electromagnetic radiation that may be connected to a wireless data link and/or cellular telephone transceiver 1012 coupled to the at least one processor 1002. The computer 1000 may also include a BT transceiver 1014, a compact disc (CD) drive 1016, a keyboard 1018, and a display 1020 all coupled to the at least one processor 1002. Other configurations of the computing device may include a computer mouse or trackball coupled to the at least one processor (e.g., via a universal serial bus (USB) input) as are well known, which may also be used in conjunction with various embodiments.

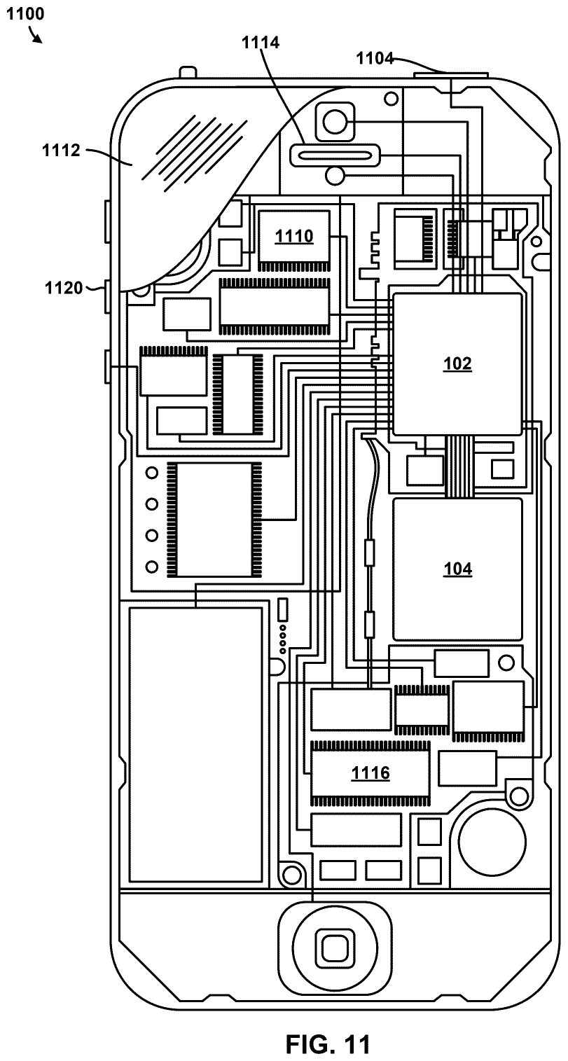

FIG. 11 is a component block diagram of a computing device 1100 suitable for use with various embodiments. With reference to FIGS. 1-11, various embodiments may be implemented on a variety of computing devices 1100, an example of which is illustrated in FIG. 11 in the form of a smartphone. The computing device 1100 may include a first SOC 102 coupled to a second SOC 104. The first and second SoCs 102, 104 may be coupled to internal memory 1116, a touch-sensitive display 1112, a user-facing camera 168, and a speaker 1114. The first and second SOCs 102, 104 may also be coupled to at least one subscriber identity module (SIM) 1140 and/or a SIM interface that may store information supporting a first 5GNR subscription and a second 5GNR subscription, which support service on a 5G non-standalone (NSA) network.

The computing device 1100 may include an antenna 1104 for sending and receiving electromagnetic radiation that may be connected to a wireless transceiver 166 coupled to one or more processors in the first and/or second SOCs 102, 104. The computing device 1100 may also include menu selection buttons or rocker switches 1120 for receiving user inputs.

The computing device 1100 also includes a sound encoding/decoding (CODEC) circuit 1110, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 1110 may include a digital signal processor (DSP) circuit (not shown separately).

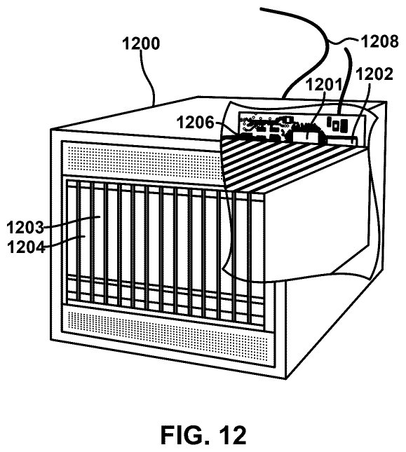

Some embodiments may be implemented on any of a variety of commercially available computing devices, such as the server computing device 1200 illustrated in FIG. 12. Such a server device 1200 may include a processor 1201 coupled to volatile memory 1202 and a large capacity nonvolatile memory, such as a disk drive 1203. The server device 1200 may also include a floppy disc drive, USB, etc. coupled to the processor 1201. The server device 1200 may also include network access ports 1206 coupled to the processor 1201 for establishing data connections with a network connection circuit 1204 and a communication network 1208 (e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within a first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including at least one processor coupled to memory and configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A processor-implemented method of securing artificial intelligence (AI) models in a computing device, the method including: retrieving, by a first processor of the computing device, an AI model that includes original model weights (W); decomposing the original model weights (W) by the first processor into lower-rank matrices including a first matrix (U), a second matrix (V), and a third matrix (Σ); designating, by the first processor, the first matrix (U) and the second matrix (V) for processing within an unsecured execution environment (UEE); designating, by the first processor, the third matrix (Σ) for processing within a secure execution environment (SEE); encrypting, by the first processor, the third matrix (Σ) in the UEE; transferring the encrypted third matrix (Σ) to the SEE; decrypting the encrypted third matrix (Σ) by a second processor within the SEE; applying the third matrix (Σ) to an adapter component by the second processor in the SEE to perform secure computations and generate inference results; and storing the inference results or third matrix (Σ) in encrypted form in a secure memory within the SEE.

Example 2. The method of example 1, in which the third matrix (Σ) is a diagonal matrix that includes singular values of the original model weights (W) derived from the decomposition operations that include sensitive, private, or personal data characteristics or features.

Example 3. The method of either of examples 1 or 2, in which designating the third matrix (Σ) as the secure component for processing within the SEE further includes the first processor encrypting and storing the third matrix (Σ) in encrypted form in the secure memory within the SEE.

Example 4. The method of any of examples 1-3, further comprising: performing non-sensitive computations involving the first matrix (U) and the second matrix (V) by the first processor in the UEE; performing the sensitive computations involving the third matrix (Σ) by the second processor within the SEE; and synchronizing computational results between the SEE and UEE by one of the first or second processors.

Example 5. The method of any of examples 1-4, further comprising training the AI model using the first matrix (U) and the second matrix (V) by the first processor in the UEE for non-sensitive training data, and using the third matrix (Σ) by the second processor in the SEE for sensitive training data.

Example 6. The method of any of examples 1-5, further including monitoring data flows between the SEE and the UEE to detect updates or potential security breaches.

Example 7. The method of any of examples 1-6, in which decomposing the original model weights (W) into the lower-rank matrices including the first matrix (U), the second matrix (V), and the third matrix (Σ) includes the first processor using a matrix decomposition algorithm to decompose the original model weights (W) into the first matrix (U), the second matrix (V), and the third matrix (Σ).

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A number of different types of memories and memory technologies are available or contemplated in the future, any or all of which may be included and used in systems and computing devices that implement various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A processor-implemented method of securing artificial intelligence (AI) models in a computing device, the method comprising:
retrieving, by a first processor of the computing device, an AI model that includes original model weights (W);
decomposing the original model weights (W) by the first processor into lower-rank matrices including a first matrix (U), a second matrix (V), and a third matrix (Σ);
designating, by the first processor, the first matrix (U) and the second matrix (V) for processing within an unsecured execution environment (UEE);
designating, by the first processor, the third matrix (Σ) for processing within a secure execution environment (SEE);
encrypting, by the first processor, the third matrix (Σ) in the UEE;
transferring the encrypted third matrix (Σ) to the SEE;
decrypting the encrypted third matrix (Σ) by a second processor within the SEE;
applying the third matrix (Σ) to an adapter component by the second processor in the SEE to perform secure computations and generate inference results; and
storing the inference results or third matrix (Σ) in encrypted form in a secure memory within the SEE.

2. The method of claim 1, wherein the third matrix (Σ) is a diagonal matrix that includes singular values of the original model weights (W) derived from the decomposition operations that include sensitive, private, or personal data characteristics or features.

3. The method of claim 1, wherein designating the third matrix (Σ) as the secure component for processing within the SEE further comprises the first processor encrypting and storing the third matrix (Σ) in encrypted form in the secure memory within the SEE.

4. The method of claim 1, further comprising:
performing non-sensitive computations involving the first matrix (U) and the second matrix (V) by the first processor in the UEE;
performing sensitive computations involving the third matrix (Σ) by the second processor within the SEE; and
synchronizing computational results between the SEE and UEE by one of the first or second processors.

5. The method of claim 1, further comprising training the AI model using the first matrix (U) and the second matrix (V) by the first processor in the UEE for non-sensitive training data, and using the third matrix (Σ) by the second processor in the SEE for sensitive training data.

6. The method of claim 1, further comprising monitoring data flows between the SEE and the UEE to detect updates or potential security breaches.

7. The method of claim 1, wherein decomposing the original model weights (W) into the lower-rank matrices including the first matrix (U), the second matrix (V), and the third matrix (Σ) comprises the first processor using a matrix decomposition algorithm to decompose the original model weights (W) into the first matrix (U), the second matrix (V), and the third matrix (Σ).

8. A computing device, comprising:
a first processor within an unsecured execution environment (UEE);
a second processor within a secure execution environment (SEE); and
a secure memory within the SEE,
wherein the first processor is configured to:
retrieve an AI model that includes original model weights (W);
decompose the original model weights (W) by the first processor into lower-rank matrices including a first matrix (U), a second matrix (V), and a third matrix (Σ);
designate the first matrix (U) and the second matrix (V) for processing within the UEE;
designate the third matrix (Σ) for processing within the SEE;
encrypt the third matrix (Σ) in the UEE; and
transfer the encrypted third matrix (Σ) to the SEE, and wherein the second processor is configured to:
decrypt the encrypted third matrix (Σ) in the SEE;
apply the third matrix (Σ) to an adapter component to perform secure computations and generate inference results in the SEE; and
store the inference results or third matrix (Σ) in encrypted form in the secure memory.

9. The computing device of claim 8, wherein the third matrix (Σ) is a diagonal matrix that includes singular values of the original model weights (W) derived from the decomposition operations that include sensitive, private, or personal data characteristics or features.

10. The computing device of claim 8, wherein designating the third matrix (Σ) as the secure component for processing within the SEE further comprises the first processor encrypting and storing the third matrix (Σ) in encrypted form in the secure memory within the SEE.

11. The computing device of claim 8, further comprising:
performing non-sensitive computations involving the first matrix (U) and the second matrix (V) by the first processor in the UEE;
performing sensitive computations involving the third matrix (Σ) by the second processor within the SEE; and
synchronizing computational results between the SEE and UEE by one of the first or second processors.

12. The computing device of claim 8, further comprising training the AI model using the first matrix (U) and the second matrix (V) by the first processor in the UEE for non-sensitive training data, and using the third matrix (Σ) by the second processor in the SEE for sensitive training data.

13. The computing device of claim 8, further comprising monitoring data flows between the SEE and the UEE to detect updates or potential security breaches.

14. The computing device of claim 8, wherein decomposing the original model weights (W) into the lower-rank matrices including the first matrix (U), the second matrix (V), and the third matrix (Σ) comprises the first processor using a matrix decomposition algorithm to decompose the original model weights (W) into the first matrix (U), the second matrix (V), and the third matrix (Σ).

15. A computing device, comprising:
means for retrieving an AI model that includes original model weights (W);
means for decomposing the original model weights (W) into lower-rank matrices including a first matrix (U), a second matrix (V), and a third matrix (Σ);
means for designating the first matrix (U) and the second matrix (V) for processing within an unsecured execution environment (UEE) of the computing device;
means for designating the third matrix (Σ) for processing within a secure execution environment (SEE) of the computing device;
means for encrypting the third matrix (Σ) in the UEE;
means for transferring the encrypted third matrix (Σ) to the SEE;
means for decrypting the encrypted third matrix (Σ) within the SEE;
means for applying the third matrix (Σ) to an adapter component in the SEE to perform secure computations and generate inference results; and
means for storing the inference results or third matrix (Σ) in encrypted form in the SEE.

16. The computing device of claim 15, wherein the third matrix (Σ) is a diagonal matrix that includes singular values of the original model weights (W) derived from the decomposition operations that include sensitive, private, or personal data characteristics or features.

17. The computing device of claim 15, wherein means for designating the third matrix (Σ) as the secure component for processing within the SEE further comprises means for encrypting and storing the third matrix (Σ) in encrypted form within the SEE.

18. The computing device of claim 15, further comprising:
means for performing non-sensitive computations involving the first matrix (U) and the second matrix (V) in the UEE;
means for performing sensitive computations involving the third matrix (Σ) within the SEE; and
means for synchronizing computational results between the SEE and UEE by one of the first or second processors.

19. The computing device of claim 15, further comprising:
means for training the AI model using the first matrix (U) and the second matrix (V) in the UEE for non-sensitive training data; and
means for using the third matrix (Σ) in the SEE for sensitive training data.

20. The computing device of claim 15, wherein means for decomposing the original model weights (W) into the lower-rank matrices including the first matrix (U), the second matrix (V), and the third matrix (Σ) comprises means for using a matrix decomposition algorithm to decompose the original model weights (W) into the first matrix (U), the second matrix (V), and the third matrix (Σ).
